(19) United States
(12) Patent Application Publication
(10) Pub. No.: US 2024/0369823 A1
(43) Pub. Date: Nov. 7, 2024

(54) DIOPTER ADJUSTMENT AND LOCKING MECHANISM USING LEFT AND RIGHT THREADING ON THE SAME PITCH DIAMETER

(71) Applicant: Sheltered Wings, Inc. d/b/a Vortex Optics, Barneveld, WI (US)

(72) Inventor: Connor McDermot, Barneveld, WI (US)

(21) Appl. No.: 18/653,370

(22) Filed: May 2, 2024

Related U.S. Application Data
(60) Provisional application No. 63/499,837, filed on May 3, 2023.

(51) Int. Cl. G02B 23/16; F41G 1/38; G02B 25/00

(52) U.S. Cl. CPC G02B 23/16; F41G 1/38; G02B 25/00

(57) ABSTRACT

The disclosure relates to locking assemblies. In one embodiment, the disclosure relates to locking assemblies having threading. In another embodiment, the disclosure relates to locking assemblies having overlapping first rotating direction thread form and second rotating direction thread form, and the second rotating direction thread form is opposite the first rotating direction thread form.

### CROSS-REFERENCE TO RELATED APPLICATIONS

This application claims priority to and is a non-provisional application of U.S. Patent Application No. 63/499,837 filed May 3, 2023, which is incorporated herein by reference in its entirety.

### FIELD

The disclosure relates to optical devices. In one embodiment, the disclosure relates to a viewing optic used as a riflescope. In another embodiment, the disclosure relates to a locking mechanism for an adjustable viewing optic that compensates for variations in eyesight from user-to-user.

### BACKGROUND

Existing riflescopes or other viewing optics for sighting, magnification, or improved image clarity (e.g., binoculars, microscopes, magnifying lenses, etc.) include mechanisms to focus the viewing optic into an optimum, focused position for a particular person. The viewing optic's optimum, focused position depends on the user's visual acuity, and so, the viewing optic's optimum, focused position varies from person-to-person. Thus, a person using the viewing optic must calibrate or focus the viewing optic before using the viewing optic for a particular purpose (e.g., hunting).

It is known in the art that locking mechanisms are desirable to lock the viewing optic into the optimum, focused position once focused by a user. By locking the viewing optic into the optimum, focused position, a user need not focus the viewing optic each time the viewing optic is used, as the viewing optic should remain in the optimum, focused position once secured. It is further known in the art that it is desirable to easily focus the viewing optic and easily lock the viewing optic into the optimum, focused position.

However, conventional viewing optic adjustment and locking mechanisms either focused quickly (sometimes known as “fast focus” viewing optics) or secured easily (sometimes known as “locking fine focus” viewing optics), but not both. Particularly, conventional fast focus viewing optics were ineffective at securing the viewing optic into the optimum, focused position because these viewing optics merely resisted unwanted focus adjustments but were unable to completely prevent unwanted focus adjustments.

Therefore, it would be desirable to provide a locking mechanism for a viewing optic that securely locks the viewing optic into a desired position and adjusts to a focused position quickly and easily.

### SUMMARY

In one embodiment, the disclosure provides a diopter adjustment and locking mechanism. In an embodiment, the diopter adjustment and locking mechanism can use both left-hand and right-hand threading on the same pitch diameter.

In one embodiment, a locking assembly comprises a scope tube including a first threading, wherein the first threading comprises overlapping first rotating direction thread form and second rotating direction thread form, and the second rotating direction thread form is opposite the first rotating direction thread form; an eyepiece housing including a second threading having the first rotating direction thread form, wherein the second threading is configured to engage with the first rotating direction thread form of the first threading; and a binding nut including a third threading having the first rotating direction thread form, wherein the third threading is configured to engage with the second rotating direction thread form of the first threading.

In one embodiment, an apparatus comprises a first threading, wherein the first threading comprises overlapping first rotating direction thread form and second rotating direction thread form, and the second rotating direction thread form is opposite the first rotating direction thread form; a second threading having the first rotating direction thread form, wherein the second threading is configured to engage with the first rotating direction thread form of the first threading; and a third threading having the first rotating direction thread form, wherein the third threading is configured to engage with the second rotating direction thread form of the first threading.

In another embodiment, a locking assembly comprises a scope tube including a first threading, wherein the first threading comprises overlapping first rotating direction thread form and second rotating direction thread form, and the second rotating direction thread form is opposite the first rotating direction thread form; an eyepiece housing including a second threading having the first rotating direction thread form, wherein the second threading is configured to engage with the first rotating direction thread form of the first threading; and a binding nut including a third threading having the first rotating direction thread form, wherein the third threading is configured to engage with the second rotating direction thread form of the first threading, wherein a first pitch diameter of the first rotating direction thread form is substantially the same as a second pitch diameter of the second rotating direction thread form.

Other embodiments will be evident from a consideration of the drawings taken together with the detailed description provided herein.

### BRIEF DESCRIPTION OF THE DRAWINGS

FIG. 1 shows a cross-sectional view of a viewing optic, in accordance with embodiments of the disclosure.

FIG. 2 is a scope tube having right-hand and left-hand threading formed thereon, in accordance with embodiments of the disclosure.

FIG. 3 is the viewing optic of FIG. 1 showing the various mechanisms of FIG. 1 locking together, in accordance with embodiments of the disclosure.

FIG. 4 is the viewing optic of FIG. 1 showing the various mechanisms of FIG. 1 unlocking, in accordance with embodiments of the disclosure.

FIG. 5 is the viewing optic of FIG. 1 showing the various mechanisms of FIG. 1 translating together, in accordance with embodiments of the disclosure.

### DETAILED DESCRIPTION

The assemblies, apparatuses and methods disclosed herein will now be described more fully hereinafter with reference to the accompanying drawings, in which embodiments of the disclosure are shown. The apparatuses and methods disclosed herein may, however, be embodied in many different forms and should not be construed as limited to the embodiments set forth herein. Rather, these embodiments are provided so that the disclosure will be thorough and complete and will fully convey the scope of the invention to those skilled in the art.

It will be appreciated by those skilled in the art that the set of features and/or capabilities may be readily adapted within the context of a stationary platform, such as a bipod, tripod, and other permutations of stationary platforms. Further, it will be appreciated by those skilled in the art that the various features and/or capabilities described herein may be deployed in various industries, including shooting, photography, surveying, and other areas in which a stable stationary platform is desired to secure a viewing optic, firearm, sight, camera, and other such device.

### Definitions

Like numbers refer to like elements throughout. It will be understood that, although the terms first, second, etc., may be used herein to describe various elements, components, regions, and/or sections, these elements, components, regions and/or sections should not be limited by these terms. These terms are used only to distinguish one element, component, region and/or section from another element, component, region and/or section. Thus, a first element, component, region or section could be termed a second element, component, region or section without departing from the disclosure.

The numerical ranges in this disclosure are approximate, and thus may include values outside of the range unless otherwise indicated. Numerical ranges include all values from and including the lower and the upper values (unless specifically stated otherwise), in increments of one unit, provided that there is a separation of at least two units between any lower value and any higher value. As an example, if a compositional, physical or other property, such as, for example, distance, speed, velocity, etc., is from 10 to 100, it is intended that all individual values, such as 10, 11, 12, etc., and sub ranges, such as 10 to 44, 55 to 70, 97 to 100, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, distances from a user of a device to a target.

Spatial terms, such as “beneath,” “below,” “lower,” “above,” “upper,” and the like, may be used herein for ease of description to describe one element's or feature's relationship to another element(s) or feature(s) as illustrated in the figures. It will be understood that the spatially relative terms are intended to encompass different orientations of device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the term “and/or” includes any and all combinations of one or more of the associated listed items. For example, when used in a phrase such as “A and/or B,” the phrase “and/or” is intended to include both A and B; A or B; A (alone); and B (alone). Likewise, the term “and/or” as used in a phrase such as “A, B and/or C” is intended to encompass each of the following embodiments” A, B and C; A, B, or C; A or C; A or B; B or C; A and C; A and B; B and C; A (alone); B (alone); and C (alone).

It will be understood that when an element or layer is referred to as being “on,” “connected to” or “coupled to” another element or layer, it can be directly on, connected or coupled to the other element or layer. Alternatively, intervening elements or layers may be present. In contrast, when an element or layer is referred to as being “directly on,” “directly connected to” or “directly coupled to” another element or layer, there are no intervening elements or layers present.

As used herein, the terms “user” and “shooter” interchangeably refer to either the operator making the shot or an individual observing the shot in collaboration with the operator making the shot.

As used herein, the term “viewing optic” refers to an apparatus or assembly used by a user, a shooter or a spotter to select, identify and/or monitor a target. A viewing optic may rely on visual observation of the target or, for example, on infrared (IR), ultraviolet (UV), radar, thermal, microwave, magnetic imaging, radiation including X-ray, gamma ray, isotope and particle radiation, night vision, vibrational receptors including ultra-sound, sound pulse, sonar, seismic vibrations, magnetic resonance, gravitational receptors, broadcast frequencies including radio wave, television and cellular receptors, or other image of the target. The image of the target presented to a user/shooter/spotter by a viewing optic may be unaltered, or it may be enhanced, for example, by magnification, amplification, subtraction, superimposition, filtration, stabilization, template matching, or other means. The target selected, identified and/or monitored by a viewing optic may be within the line of sight of the shooter or tangential to the sight of the shooter. In other embodiments, the shooter's line of sight may be obstructed while the viewing optic presents a focused image of the target. The image of the target acquired by the viewing optic may, for example, be analog or digital, and shared, stored archived or transmitted within a network of one or more shooters and spotters by, for example, video, physical cable or wire, IR, radio wave, cellular connections, laser pulse, optical 802.11b or other wireless transmission using, for example, protocols such as html. SML, SOAP, X.25, SNA, etc., Bluetooth™, Serial, USB or other suitable image distribution method. The term “viewing optic” is used interchangeably with “optic sight.”

As used herein, a “firearm” is a portable gun, being a barreled weapon that launches one or more projectiles often driven by the action of an explosive force. As used herein, the term “firearm” includes a handgun, a long gun, a rifle, shotgun, a carbine, automatic weapons, semi-automatic weapons, a machine gun, a sub-machine gun, an automatic rifle and an assault rifle.

As used herein, “left-hand threading” or “left-hand thread form” mean threading that runs counterclockwise. Additionally, left-hand threading or left-hand thread form are threads that cause an object rotating on the threading to translate forward in response to a clockwise rotate and further translate backward in response to a counterclockwise rotation.

As used herein, “right-hand threading” or “right-hand thread form” mean threading that runs clockwise. Additionally, right-hand threading or right-hand thread form are threads that cause an object rotating on the threading to translate forward in response to a counterclockwise rotate and further translate backward in response to a clockwise rotation.

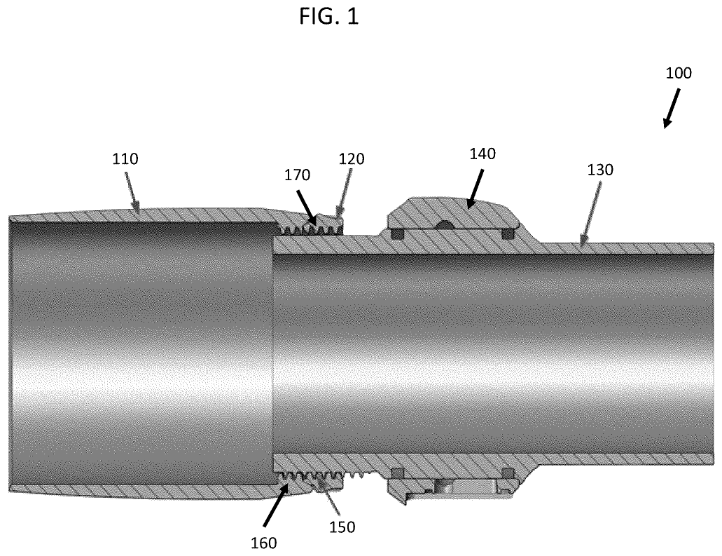

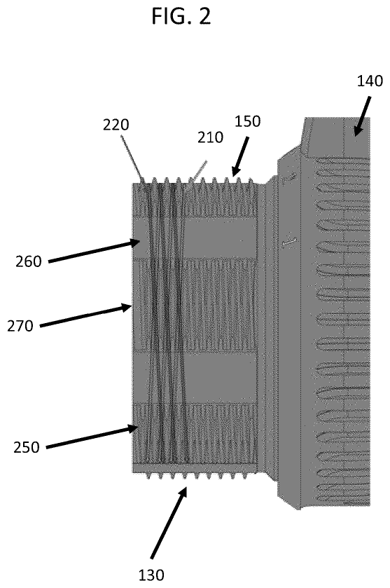

FIG. 1 is a cross-sectional view of a viewing optic 100 having the left-hand and right-hand threading disclosed herein. In the embodiment shown, the viewing optic 100 includes an eyepiece housing 110, a binding nut 120, and a scope tube 130. The viewing optic 100 may further include a magnification adjustment ring 140. In the embodiment shown in FIG. 1, the scope tube 130 may include a first threading 150 having overlapping left-hand and right-hand threading of the same or substantially the same dimensions. More specifically, the first threading 150 may comprise threads having the same or substantially the same pitch, flank angle, and/or pitch diameter for both the left-hand thread form and the right-hand thread form. The first threading 150 having the overlapping left-hand and right-hand threading is better shown in FIG. 2, discussed further below. In some embodiments, the first threading 150 comprises a coarse pitch for fast adjustment of the eyepiece housing 110.

According to an exemplary embodiment, the eyepiece housing 110 can comprise a cylindrical housing that houses a diopter lens and any other optical components to focus, magnify or otherwise clarify a line of sight or target image. In addition, the eyepiece housing 110 can include second threading 160 configured to couple with the first threading 150 of the scope tube 130. According to an exemplary embodiment, the second threading 160 can be unidirectional such that rotating the eyepiece housing 110 in a first rotating direction translates the eyepiece housing 110 in a first direction with respect to the scope tube 130. The first rotating direction can be either the right-hand rotating direction or the left-hand rotating direction. In this way, a user can rotate the eyepiece lens 110 such that the eyepiece housing 110 translates along the first threading 150 and focuses the diopter within the eyepiece housing 110. In some embodiments, the second threading 160 comprises a coarse pitch to correspond and couple with the first threading 150.

The viewing optic 100 can further include a binding nut 120 comprising third threading 170 also configured to couple with the first threading 150 of the scope tube 130. The third threading 170 comprises the opposite rotating direction threading as the second threading 160. For example, if the second threading 160 is right-hand threading, then the third threading 170 is left-hand threading, or vice versa. According to an exemplary embodiment, the third threading 170 can be unidirectional such that rotating the binding nut 120 in a second rotating direction translates the binding nut 120 in a second direction with respect to the scope tube 130. The second rotating direction can be either the right-hand rotating direction or the left-hand rotating direction, but the second rotating direction is opposite the first rotating direction. In this way, a user can rotate the binding nut 120 such that the binding nut 120 translates along the first threading 150 and engages the eyepiece housing 110. In some embodiments, the third threading 170 comprises a coarse pitch to correspond and couple with the first threading 150.

For example, if the eyepiece housing 110 translates in the first direction by rotating in the right-hand direction, then the binding nut 120 translates in the second, opposite direction when the binding nut 120 rotates in the left-hand direction (or vice versa). Said in another manner, if the second threading 160 runs clockwise, then the third threading 170 runs counterclockwise. Because the first threading 150 includes bidirectional threading, both the eyepiece housing 110 and the binding nut 2 can both rotate on the first threading 150.

Moreover, the binding nut 120 can rotate to engage the eyepiece housing 110. For example, a user can rotate the eyepiece housing 110 in the first rotating direction, thereby moving the eyepiece housing 110 into a position that focuses the target image for the user depending on the user's eyesight. Then, once the eyepiece housing 110 is in place, the user can subsequently rotate the binding nut 120 in the second rotating direction, which is opposite the first rotating direction, and cause the binding nut 120 to engage the eyepiece housing 110. In some embodiments, the user can apply one final torque to the eyepiece housing 110, after the binding nut 120 has rotated up to the point of engaging the eyepiece housing 110, to lock the eyepiece housing 110. Because the eyepiece housing 110 and the binding nut 120 have threading of opposite directions, the binding nut 120 can lock the eyepiece housing 110 into place one the binding nut 110 engages the eyepiece housing 110. Thus, locking the eyepiece housing 110 into a focused position is as easy as rotating the binding nut 120 until it engages the eyepiece housing 110, thereby providing both a secure lock and fast adjustment and locking, which is an improvement over the prior art.

The scope tube 130 can include other components to aid in generating a clear and magnified target image. For example, the scope tube 130 can include a magnification adjustment ring 140 configured to adjust or move a magnifying lens housed within either the scope tube 130, the eyepiece housing 110, or both. Although not illustrated the viewing optic 100 can further include other components, such as but not limited to, an elevation turret, an objective lens, illumination components, illumination control buttons, a battery, windage turrets, slide focus knows, etc.

Referring now to FIG. 2, as shown, the scope tube 130 includes the first threading 150 that includes both a left-hand thread form 210 and a right-hand thread form 220. In an embodiment, the right-hand thread form 220 and the left-hand thread form 210 formed on the scope tube 130 can overlap. Additionally, in one embodiment, the left-hand thread form 210 can have the same thread dimensions as the right-hand thread form 220. In one exemplary embodiment, the right-hand thread form 220 and the left-hand thread form 210 can both have the dimensions shown in Table 1:

TABLE 1
Scope Tube Thread Dimensions
Tr38.0X4.5(P1.5) - RH/LH - 3 STARTS
MAJ. 37.940 ± 0.050
P.D. 37.219 ± 0.050
MIN. 36.180 ± 0.050

Recited differently, the first threading 150 can be machined such that it has both clockwise and counterclockwise threading. Additionally, in some embodiments, the first threading 150 may not be formed all 360° around the scope tube 130. As shown in FIG. 2, the scope tube 130 can include threading sections 250 and bare sections 260. In an embodiment, the threading sections 250 can include threading formed or machined into the scope tube 130. Meanwhile, the bare sections 260 can remain smooth and round without any threading formed thereon. In one embodiment, the scope tube 130 includes six threading sections 250 and six bare sections 260. The first threading 150 can be formed on the scope tube 130 between the magnification ring 140 and a first end 270 of the scope tube 130.

Because the right-hand thread form 220 and the left-hand thread form 210 overlap, the right-hand thread form 220 and the left-hand thread form 210 can form an “X” shape when viewed in a cross-section or from the side, which is shown in FIG. 2.

Additionally, the second threading 160 and the third threading 170 have the same or similar threading dimensions as the first threading 150 so that the second threading 160 and the third threading 170 can couple to the first threading. In one exemplary embodiment, the second threading 160 and the third threading 170 can both have the dimensions shown in Table 2:

TABLE 2

| Binding Nut Coarse Thread | Eyepiece Housing Coarse Thread |
|---|---|
| Tr38.0X4.5(P1.5) - LH - 3 STARTS | Tr38.0X4.5(P1.5) - 3 STARTS |
| 38.539 MAJ. +/− 0.050 | 38.539 MAJ. +/− 0.050 |
| 37.500 P.D. +/− 0.050 | 37.500 P.D. +/− 0.050 |
| 36.547 MIN. +/− 0.050 | 36.547 MIN. +/− 0.050 |

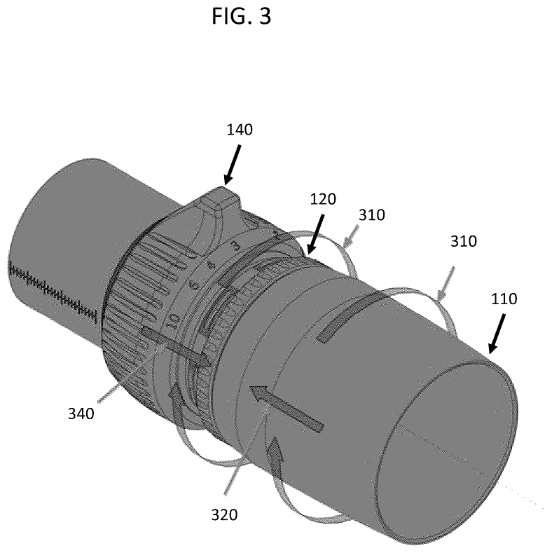

FIG. 3 illustrates the binding nut 120 and the eyepiece housing 110 engaging and locking into place according to an exemplary embodiment. As shown, the eyepiece housing 110 can rotate in a first rotating direction (e.g., clockwise) direction 310, and the right-hand threads included at a first end of the eyepiece housing 110 can move the eyepiece housing 110 in a first direction 320 toward the magnifying ring 140. Also, the binding nut 120 can rotate in the first rotating (e.g., clockwise) direction 310, and the left-hand threads of the binding nut 120 can move the binding nut 120 in a second direction 340 away from the magnifying ring 140. The binding nut 120 can rotate clockwise on the left-hand thread form of the first threading 150, and the eyepiece housing 110 can rotate clockwise on the right-hand thread form of the first threading 150 at the same time. The result can move the binding nut 120 toward the eyepiece housing 110 causing the binding nut 120 and the eyepiece housing 110 to engage and lock the eyepiece housing 110 into a desired position determined by the user to focus the viewing optic 100.

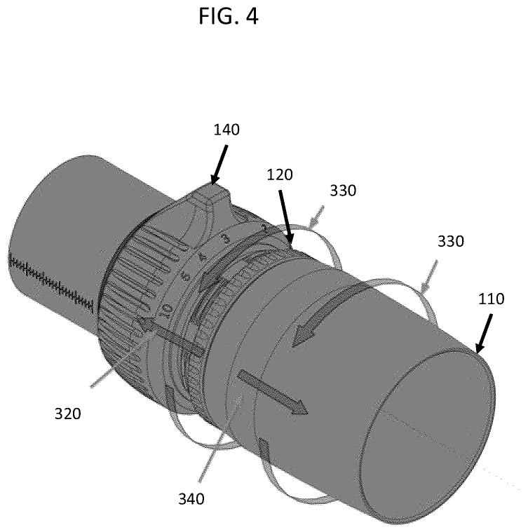

FIG. 4 illustrates the binding nut 120 and the eyepiece housing 110 unlocking according to an exemplary embodiment. As shown, the eyepiece housing 110 can rotate in a second rotating (e.g., counterclockwise) direction 330, and the right-hand threads included at a first end of the eyepiece housing 110 can move the eyepiece housing 110 in the second direction 340 away from the magnifying ring 140. Also, the binding nut 120 can rotate in the second rotating (e.g., counterclockwise) direction 330, and the left-hand threads of the binding nut 120 can move the binding nut 120 in the first direction 320 toward the magnifying ring 140. The binding nut 120 can rotate counterclockwise on the left-hand thread form of the first threading 150, and the eyepiece housing 110 can rotate counterclockwise on the right-hand thread form of the first threading 150 at the same time. The result can move the binding nut 120 away from the eyepiece housing 110 causing the binding nut 120 and the eyepiece housing 110 to disengage and unlock the eyepiece housing 110.

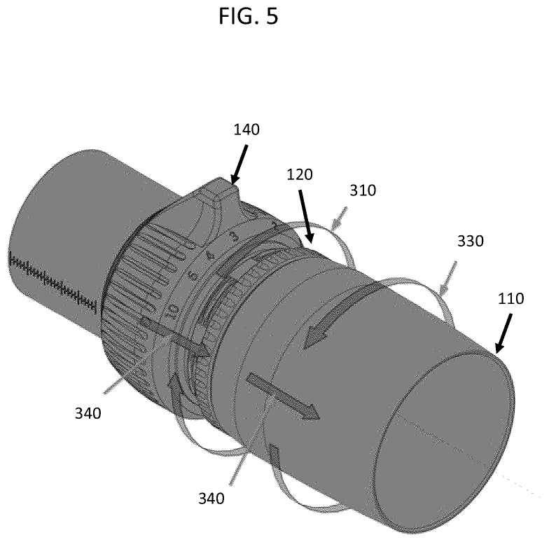

FIG. 5 illustrates the binding nut 120 and the eyepiece housing 110 translating together according to an exemplary embodiment. As shown, the eyepiece housing 110 can rotate in the first rotating (e.g., clockwise) direction 310, and the right-hand threads included at a first end of the eyepiece housing 110 can move the eyepiece housing 110 in the second direction away from the magnifying ring 140. Also, the binding nut 120 can rotate in the first rotating (e.g., clockwise) direction 310, and the left-hand threads of the binding nut 120 can move the binding nut 120 in the second direction 340 away from the magnifying ring 140. The binding nut 120 can rotate clockwise on the left-hand thread form of the first threading 150, and the eyepiece housing 110 can rotate counterclockwise on the right-hand thread form of the first threading 150 at the same time. The result can move the binding nut 120 and the eyepiece housing 110 away from the magnifying ring 140 together. Although not shown, the binding nut 120 and the eyepiece housing 110 can translate together in the first direction 320, toward the magnifying ring 140, together when the binding nut 120 rotates counterclockwise and the eyepiece housing 110 rotates clockwise.

A force required to separate the binding nut 120 and the eyepiece housing 110 can depend on a material selected for the binding nut 120. A more compliant material will allow more compression on the tapered faces of the binding nut 120 and eyepiece housing 110. This compression will increase the static friction between a threading surface of the binding nut 120 and a threading surface of eyepiece housing 110, which can require a higher torque to separate the binding nut 120 and eyepiece housing 110. And harder material can have the opposite effect and can be easier to separate and unlock.

The disclosure is now further described by the following paragraphs:

1. A locking assembly comprising:
a scope tube including a first threading, wherein the first threading comprises overlapping first rotating direction thread form and second rotating direction thread form, and the second rotating direction thread form is opposite the first rotating direction thread form;
an eyepiece housing including a second threading having the first rotating direction thread form, wherein the second threading is configured to engage with the first rotating direction thread form of the first threading; and
a binding nut including a third threading having the first rotating direction thread form, wherein the third threading is configured to engage with the second rotating direction thread form of the first threading.

2. The locking assembly of paragraph 1, wherein the first rotating direction is left-hand threading.

3. The locking assembly of any of the preceding paragraphs, wherein the second rotating direction is right-hand threading.

4. The locking assembly of any of the preceding paragraphs, wherein the first rotating direction is right-hand threading.

5. The locking assembly of any of the preceding paragraphs, wherein the second rotating direction is left-hand threading.

6. The locking assembly of any of the preceding paragraphs, wherein the eyepiece housing is configured to rotate on the first threading according to the first rotating direction thread form causing the eyepiece housing to translate in a first direction towards a magnifying lens formed on the scope tube.

7. The locking assembly of any of the preceding paragraphs, wherein the binding nut is configured to rotate on the first threading according to the second rotating direction thread form causing the binding nut to translate in a second direction away from the magnifying lens formed on the scope tube.

8. The locking assembly of any of the preceding paragraphs, wherein the binding nut is configured to translate in the second direction while the eyepiece lens translates in the first direction, thereby causing the binding nut to engage the eyepiece housing and lock the eyepiece housing into a desired location upon engaging the eyepiece housing.

9. The locking assembly of any of the preceding paragraphs, wherein the binding nut is further configured to translate in the first direction when rotating in the opposite direction, thereby causing the binding nut to disengage the eyepiece housing and unlock the eyepiece housing from the desired location.

10. The locking assembly of any of the preceding paragraphs, wherein a first pitch diameter of the first rotating direction thread form is substantially the same as a second pitch diameter of the second rotating direction thread form.

11. The locking assembly of any of the preceding paragraphs, wherein the eyepiece housing further comprises: a diopter.

12. The locking assembly of any of the preceding paragraphs, wherein the scope tube includes threading sections and bare sections, and wherein the first threading is formed in the threading sections.

13. An apparatus comprising:
a first threading, wherein the first threading comprises overlapping first rotating direction thread form and second rotating direction thread form, and the second rotating direction thread form is opposite the first rotating direction thread form;
a second threading having the first rotating direction thread form, wherein the second threading is configured to engage with the first rotating direction thread form of the first threading; and a third threading having the first rotating direction thread form, wherein the third threading is configured to engage with the second rotating direction thread form of the first threading.

14. The apparatus of paragraph 13, wherein the first rotating direction is left-hand threading.

15. The apparatus of any of the preceding paragraphs, wherein the second rotating direction is right-hand threading.

16. The apparatus of any of the preceding paragraphs, wherein the first rotating direction is right-hand threading.

17. The apparatus of any of the preceding paragraphs, wherein the second rotating direction is left-hand threading.

18. The apparatus of any of the preceding paragraphs, wherein a first pitch diameter of the first rotating direction thread form is substantially the same as a second pitch diameter of the second rotating direction thread form.

19. A locking assembly comprising:
a scope tube including a first threading, wherein the first threading comprises overlapping first rotating direction thread form and second rotating direction thread form, and the second rotating direction thread form is opposite the first rotating direction thread form;
an eyepiece housing including a second threading having the first rotating direction thread form, wherein the second threading is configured to engage with the first rotating direction thread form of the first threading; and
a binding nut including a third threading having the first rotating direction thread form, wherein the third threading is configured to engage with the second rotating direction thread form of the first threading,
wherein a first pitch diameter of the first rotating direction thread form is substantially the same as a second pitch diameter of the second rotating direction thread form.

20. The locking assembly of paragraph 19, wherein the eyepiece housing is configured to rotate on the first threading according to the first rotating direction thread form causing the eyepiece housing to translate in a first direction towards a magnifying lens formed on the scope tube, and wherein the binding nut is configured to rotate on the first threading according to the second rotating direction thread form causing the binding nut to translate in a second direction away from the magnifying lens formed on the scope tube while the eyepiece lens translates in the first direction, thereby causing the binding nut to engage the eyepiece housing and lock the eyepiece housing into a desired location upon engaging the eyepiece housing.

Various modifications and variations of the described structures, assemblies, apparatuses and methods of the invention will be apparent to those skilled in the art without departing from the scope and spirit of the invention. One skilled in the art will recognize at once that it would be possible to construct the present invention from a variety of materials and in a variety of different ways. Although the invention has been described in connection with specific preferred embodiments, it should be understood that the invention should not be unduly limited to such specific embodiments. While the preferred embodiments have been described in detail, and shown in the accompanying drawings, it will be evident that various further modifications are possible without departing from the scope of the invention as set forth in the appended claims. Indeed, various modifications of the described modes for carrying out the invention which are obvious to those skilled in marksmanship or related fields are intended to be within the scope of the following claims.

What is claimed is:

1. A locking assembly comprising:
a scope tube including a first threading, wherein the first threading comprises overlapping first rotating direction thread form and second rotating direction thread form, and the second rotating direction thread form is opposite the first rotating direction thread form;
an eyepiece housing including a second threading having the first rotating direction thread form, wherein the second threading is configured to engage with the first rotating direction thread form of the first threading; and
a binding nut including a third threading having the first rotating direction thread form, wherein the third threading is configured to engage with the second rotating direction thread form of the first threading.

2. The locking assembly of claim 1, wherein the first rotating direction is left-hand threading.

3. The locking assembly of claim 2, wherein the second rotating direction is right-hand threading.

4. The locking assembly of claim 1, wherein the first rotating direction is right-hand threading.

5. The locking assembly of claim 4, wherein the second rotating direction is left-hand threading.

6. The locking assembly of claim 1, wherein the eyepiece housing is configured to rotate on the first threading according to the first rotating direction thread form causing the eyepiece housing to translate in a first direction towards a magnifying lens formed on the scope tube.

7. The locking assembly of claim 1, wherein the binding nut is configured to rotate on the first threading according to the second rotating direction thread form causing the binding nut to translate in a second direction away from the magnifying lens formed on the scope tube.

8. The locking assembly of claim 1, wherein the binding nut is configured to translate in the second direction while the eyepiece lens translates in the first direction, thereby causing the binding nut to engage the eyepiece housing and lock the eyepiece housing into a desired location upon engaging the eyepiece housing.

9. The locking assembly of claim 1, wherein the binding nut is further configured to translate in the first direction when rotating in the opposite direction, thereby causing the binding nut to disengage the eyepiece housing and unlock the eyepiece housing from the desired location.

10. The locking assembly of claim 1, wherein a first pitch diameter of the first rotating direction thread form is substantially the same as a second pitch diameter of the second rotating direction thread form.

11. The locking assembly of claim 1, wherein the eyepiece housing further comprises: a diopter.

12. The locking assembly of claim 1, wherein the scope tube includes threading sections and bare sections, and wherein the first threading is formed in the threading sections.

13. An apparatus comprising:
a first threading, wherein the first threading comprises overlapping first rotating direction thread form and second rotating direction thread form, and the second rotating direction thread form is opposite the first rotating direction thread form;
a second threading having the first rotating direction thread form, wherein the second threading is configured to engage with the first rotating direction thread form of the first threading; and
a third threading having the first rotating direction thread form, wherein the third threading is configured to engage with the second rotating direction thread form of the first threading.

14. The apparatus of claim 13, wherein the first rotating direction is left-hand threading.

15. The apparatus of claim 14, wherein the second rotating direction is right-hand threading.

16. The apparatus of claim 13, wherein the first rotating direction is right-hand threading.

17. The apparatus of claim 16, wherein the second rotating direction is left-hand threading.

18. The apparatus of claim 13, wherein a first pitch diameter of the first rotating direction thread form is substantially the same as a second pitch diameter of the second rotating direction thread form.

19. A locking assembly comprising:
a scope tube including a first threading, wherein the first threading comprises overlapping first rotating direction thread form and second rotating direction thread form, and the second rotating direction thread form is opposite the first rotating direction thread form;
an eyepiece housing including a second threading having the first rotating direction thread form, wherein the second threading is configured to engage with the first rotating direction thread form of the first threading; and
a binding nut including a third threading having the first rotating direction thread form, wherein the third threading is configured to engage with the second rotating direction thread form of the first threading,
wherein a first pitch diameter of the first rotating direction thread form is substantially the same as a second pitch diameter of the second rotating direction thread form.

20. The locking assembly of claim 19, wherein the eyepiece housing is configured to rotate on the first threading according to the first rotating direction thread form causing the eyepiece housing to translate in a first direction towards a magnifying lens formed on the scope tube, and
wherein the binding nut is configured to rotate on the first threading according to the second rotating direction thread form causing the binding nut to translate in a second direction away from the magnifying lens formed on the scope tube while the eyepiece lens translates in the first direction, thereby causing the binding nut to engage the eyepiece housing and lock the eyepiece housing into a desired location upon engaging the eyepiece housing.
